(19) United States
(12) Patent Application Publication
(10) Pub. No.: US 2022/0234769 A1
(43) Pub. Date: Jul. 28, 2022

(54) BREAD SLICER ALLOWING SLICED BREAD TO BE BAGGED

(71) Applicant: JAC S.A., Liège (BE)

(72) Inventors: Baudouin Van Cauwenberghe, Liège (BE); Jens RUMSFELD, Liège (BE)

(21) Appl. No.: 17/433,857

(22) PCT Filed: Feb. 25, 2020
(86) PCT No.: PCT/IB2020/051615

§ 371 Date: Apr. 4, 2022

(30) Foreign Application Priority Data
Feb. 25, 2019 (BE) BE 2019/5118

(51) Int. Cl. B65B 25/18; B26D 7/06; B26D 1/00; B65B 35/20; B65B 43/28; B65B 43/36

(52) U.S. Cl. CPC B65B 25/18; B26D 7/0608; B26D 1/0006; B26D 2001/0066; B65B 43/28; B65B 43/36; B65B 35/20

(57) ABSTRACT

Bread slicer allowing a loaf of bread (2) to be packed in a bag, comprising a loading compartment (1) which is connected to a receiving compartment (6), a pushing member (5) which allows the bread (2) to be pushed in a movement direction of the bread and means for keeping a packing bag (13) open. The slicer comprises an abutment element (19) for reducing the cross-section of the bag (13) at the location of the abutment element (13) so that the portion (21) of the bag with a reduced cross-section forms an abutment for the end of the sliced bread.

The invention concerns a bread slicer which makes it possible to wrap bread in a packing bag.

This slicer comprises a loading compartment with a support surface to place a loaf of bread to be cut on. The loading compartment is connected to a receiving compartment which has an output table for the sliced bread. A push rod is used to push the bread from the loading compartment to the receiving compartment in a direction of travel of the bread.

To cut successive slices of bread as the latter is being moved from the loading compartment to the receiving compartment, a cutting element is provided. This cutting element is arranged in a cutting plane between the loading compartment and the receiving compartment and is substantially perpendicular to the direction of travel of the bread.

Holding means are provided in the receiving compartment for holding a packing bag having an opening, which is open with the opening facing the cutting plane. These holding means allow the packing bag to be held open while the bread is moving in the direction of travel, whereas the push rod is arranged so as to push at least a part of the sliced bread through the opening of the bag in said direction of travel in order to introduce the sliced bread at least partially into the packing bag.

Document DE 9310344 U1 describes, for example, such a slicer in which the holding means comprise a blowing nozzle creating an air flow to open the flat-folded packing bag and to hold the bag open. This slicer has the disadvantage that the slices of bread fall as they are introduced into the bag and the sliced bread falls apart in the bag.

The slicer disclosed in document EP 2799345 prevents the bread slices from falling in the bag, but requires the use of packing bags with a rigid bottom specially adapted to this slicer.

Document WO 2018/161982 describes a slicer which has a push element that makes it possible to open the packing bag while the bread is being cut. The cut slices of bread push against said push element to advance it. Thus, the slices can be compressed when they push against the push element with too much force, or they can fall and thus move apart when the push element's resistance to movement is too weak. Indeed, the effectiveness of the push element depends on the type of bread and the thickness of the bread slices.

The invention aims to remedy these disadvantages by presenting a bread slicer with which it is possible to wrap a loaf of bread while it is being sliced in a conventional preformed packing bag while ensuring that the slices of bread are held against each other in the bag without falling and thus decomposing the bread or without being compressed. Furthermore, the invention aims to provide a packing system that is independent of the type of bread to be sliced, in particular independent of the specific weight or hardness of the bread.

To this end, the slicer according to the invention comprises a push element which is provided in the receiving compartment and which makes it possible to compress the packing bag while the latter is being held open by the holding means in order to reduce the cross-section of the bag at the push element, so that the part of the bag with a reduced cross-section forms a support for the end of the loaf opposite the end facing the push rod. The push element can at least move in the direction of travel of the bread so that it can move away from the cutting plane as the sliced part of the bread is being introduced into the bag.

Advantageously, the push element cooperates with the push rod so as to allow a synchronized movement of the push element and the push rod when the bread is being cut into slices.

In an interesting embodiment of the slicer according to the invention, the holding means comprise a clamping element for holding a lower side of the opening of the packing bag substantially at the level of the output table, and an opening device for holding the upper side of the bag at the opening and for moving this upper side away from the lower side until the bag opens for the introduction of a loaf.

In an advantageous embodiment of the invention, the output table is inclined with respect to a horizontal plane to hold the slices of the cut bread against each other while the bread is being introduced into the packing bag.

In a particular embodiment of the invention, the slicer comprises a storage space for accommodating a stack of flat-folded packing bags with their opening directed towards the cutting plane. This storage space has a mobile support for said stack which allows the level of the stack of bags to be adapted so that the upper surface of this stack extends substantially in the plane of the output table.

The invention also relates to a method for cutting a loaf of bread into slices and for introducing these slices in a packing bag, wherein the bread is placed in a loading compartment and is moved in a direction of travel of the bread towards a receiving compartment by pushing it with a push rod. During this movement, preferably in discrete successive steps, the bread is cut into successive slices by a blade which moves in a cutting plane between the loading compartment and the receiving compartment. A packing bag having an opening is held in the receiving compartment with the opening of the bag directed towards the cutting plane to introduce the slices of bread into the bag along said direction of travel as the bread moves.

The method is characterized in that the packing bag is compressed by a push element in order to reduce the cross-section of a portion of the bag while the bag is being held open. Thus, the end of the loaf opposite the end facing the push rod will rest in the bag against the portion of the bag with the reduced cross-section. According to the method, the push element is moved synchronously with the push rod to move the portion with the reduced cross-section away from the cutting plane in said direction of travel as the sliced portion of the loaf is being introduced into the bag while maintaining the end of the loaf supported by said portion of the bag with the reduced cross-section.

Further details and particularities of the invention will become clear from the following description, given by way of example without being limitative in any way, of some particular embodiments of the slicer and the method according to the invention, with reference to the accompanying drawings.

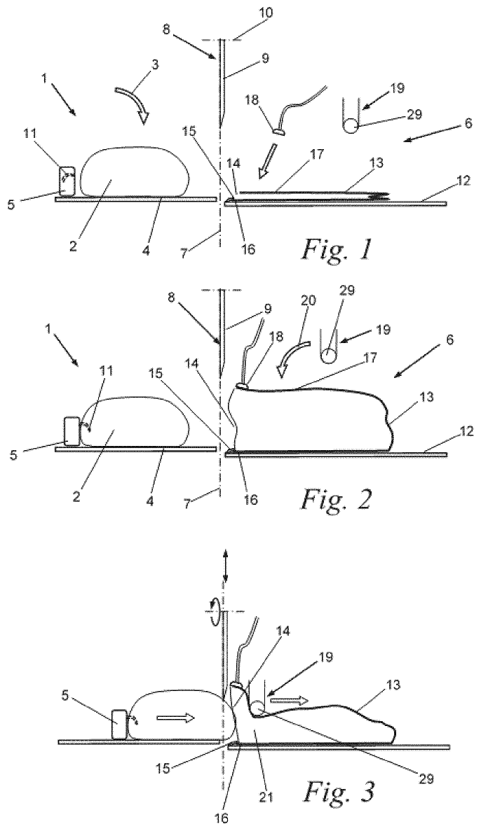

FIG. 1 is a schematic side view of a slicer comprising a loading compartment, a cutting element and a receiving compartment with an output table according to a particular embodiment of the invention, when a loaf of bread to be cut has been introduced into the loading compartment.

FIG. 2 is a view similar to that in FIG. 1, with an open packing bag for the bread.

FIG. 3 is a view similar to that of FIGS. 1 and 2, with the cross-section of the packing bag being reduced by a push element.

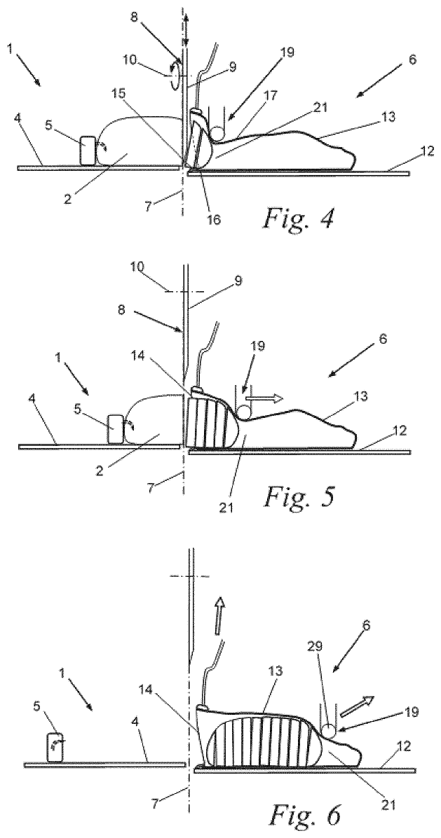

FIGS. 4 and 5 show a view similar to that of the previous figures with the bread being cut into slices and the sliced part of the bread being introduced in the packing bag.

FIG. 6 is a view similar to that of the previous figures with the sliced bread being completely introduced in the packing bag.

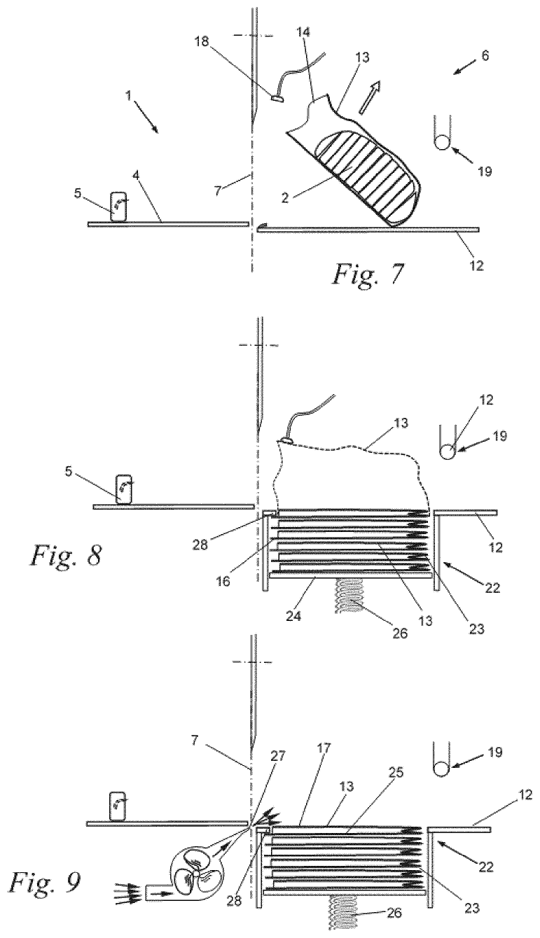

FIG. 7 is a view similar to that of the previous figures and shows the removal of the bagged sliced bread.

FIG. 8 is a view similar to that of the preceding figures of a bread slicer according to an alternative embodiment of the invention having a storage space to accommodate a stack of packing bags.

FIG. 9 is a view similar to that of the preceding figures of a bread slicer according to another embodiment of the invention with a blowing nozzle for opening the packing bags.

In the different figures, the same reference figures refer to similar or identical elements.

The invention generally relates to a slicer and a method wherein a loaf of bread is cut into slices and, while being sliced, introduced in a preformed bag.

The invention is especially interesting to be applied in stores where consumers can choose a loaf of bread, cut it with an automatic bread slicer and take the cut bread themselves. The application of the invention is not limited to supermarkets, but can also be used in any place where bread is cut by an automatic slicer, such as in a baker's shop, for example.

To cut the bread into slices, it is placed on the bottom of a slicer's loading compartment and then pushed by a push rod through a cutting plane towards an output table from where the cut bread is fed into a bag and collected by the consumer. A cutting blade moves back and forth in said cutting plane to cut successive slices of bread as it passes through the cutting plane.

The invention generally relates to a system for packing sliced bread in a preformed bag, wherein the bread is cut and introduced in the packing bag while being sliced without the need to hold the bread by hand.

A first embodiment of the slicer and the method according to the invention is schematically shown in FIGS. 1 to 7. The slicer comprises a loading compartment 1 for receiving a loaf of bread 2 to be cut. As indicated by the arrow 3, the loaf of bread 2 is placed on a support surface 4 of the loading compartment 1 of the slicer.

In this loading compartment 1 is arranged a push rod 5 making it possible to push the bread 2 to be cut in a direction of travel of the bread 2 from the loading compartment 1 towards a receiving compartment 6. A cutting plane 7 extends substantially transversely to said direction of travel between the loading compartment 1 and the receiving compartment 6. A cutting element 8, such as for example a blade, may move back and forth along the cutting plane 7 to cut successive slices of the bread 2 as it passes through said cutting plane 7. Preferably, this cutting element 8 comprises a circular blade 9 which is driven around its central axis 10.

The direction of travel of the bread 2 is generally parallel to the support surface 4 of the loading compartment 1 and/or parallel to the output table 12 in the receiving compartment 6.

In the embodiment of the slicer shown in the figures, the push rod 5 comprises at least one hook 11 which is movable between a retracted position and an extended position. Thus, as shown in FIGS. 2 to 5, the hook 11 is in the extended position when penetrating the bread to grab and hold it. Nevertheless, it is not essential that the push rod 5 has such a retractable hook 11 in the slicer according to the invention.

The bottom of the receiving compartment 6 comprises an output table 12 on which a packing bag 13 for the bread 2 can be placed. As shown in FIG. 1, the packing bag 13 is placed on the output surface 12 as folded, with its opening 14 directed towards the cutting plane 7. The packing bag 13 is, for example, a conventional paper or plastic bag that is commonly used for packing bread.

In the receiving compartment 6, holding means are provided which enable the packing bag 13 to be held open with the opening 14 facing the cutting plane 7. Preferably, these holding means do not only ensure that the bag 13 is held open, but also allow the bag 13 to be opened from its folded state.

Thus, when a flat-folded packing bag 13 is provided with the opening 14 of the bag 13 facing the cutting plane 7, the bag 13 is detachably attached to the output table 12 by a clamp 15. In particular, a lower edge 16 of the opening 14 on the lower side of the bag 13 is clamped between the clamp 15 and the output table 12. Preferably, said lower edge 16 extends beyond the upper edge of the opening 14 of the bag 13 to facilitate the attachment of the bag to the output table 12, for example.

The slicer according to the invention has holding means for holding open the packing bag 13 with the opening 14 facing the cutting plane 7. These holding means comprise a clamping element for holding the lower side of the opening 14 of the packing bag 13, in particular said lower edge 16, substantially at the level of the output table 12. In the embodiment of FIGS. 1 to 7, this clamping element comprises the aforementioned clamp 15.

The holding means also have an opening device for holding the upper side 17 of the bag 13 at the opening 14 and for moving said upper side 17 away from the bottom edge 16 until the bag 13 opens so as to allow a loaf of bread 2 to be introduced in the bag.

In the slicer of FIGS. 1 to 7, the opening device comprises at least one suction cup 18 for sucking on and holding the upper side 17 of the bag 13 in order to open it and keep it open. As shown in FIG. 1, the suction cup 18 is moved towards the upper side 17 of the bag 13, preferably close to the opening 14. The suction cup 18 sucks on the upper side 17 of the packing bag 13 so that the bag is fixed to the suction cup 18. Subsequently, the suction cup 18 is moved upwards so that the upper side 17 of the bag 13 moves away from the lower edge 16 and the bag opens with the opening 14 directed towards the cutting plane 7, as shown in FIG. 2.

The slicer may comprise a single suction cup 18 or a series of suction cups which are arranged next to each other so that they can be fixed across the entire width of the opening 14 to the upper side 17 of the bag.

The distance between the open bag 13 or opening 14 and the cutting plane 7 is preferably smaller than the width of a cut slice of the bread 2 in the direction of travel of the bread 2.

To cut the bread 2 into slices, the latter is advanced by the push rod 5 in discrete steps from the loading compartment 1 to the receiving compartment 6 across the cutting plane 7. Each time the bread is advanced over a distance corresponding to the width of a slice, the blade 9 is driven and moved along the cutting plane 7 between the two compartments 1 and 6 to cut a slice off the bread 2. In order to cut a subsequent slice, the bread 2 is advanced again by one step corresponding to the width of a slice. As a result of this movement of the bread 2, the slice that has just been cut is pushed further into the packing bag 13, as shown schematically in FIGS. 4 and 5.

In order to prevent the cut slices from falling in the bag 13 and the cut part of the bread 2 from decomposing, the slicer according to the invention comprises a push element 19 which is provided in the receiving compartment 6. In FIG. 1, the push element 19 is shown in a rest position.

The push element 19 comprises, for example, a rod or roller 29 which extends substantially horizontally and transversely to the direction of travel of the bread 2.

This push element 19 can be moved towards the packing bag 13 and makes it possible to compress said packing bag 13 at least partially while the latter is being held open by the holding means. In FIG. 2, the arrow 20 indicates the movement of the push element 19 towards the bag 13.

By partially compressing the bag 13, which is being held open, the push element 19 reduces the cross-section of the bag 13 at this push element 19, as shown in FIG. 3. Thus, the portion 21 of the bag 13 with the reduced cross-section forms a support for the end of the bread 2 opposite the end facing the push rod 5.

It is ensured, for example, that the sectional extent of this portion 21 of the bag 13 with the reduced section is smaller than the cutting surface of the slices of bread 2. In this way, the slice adjacent to this reduced section of the bag 13 will rest against the bag at the portion 21 with said reduced section. This prevents the slice from falling. Each slice that is cut from the loaf 2 rests against the previous slice, as shown in FIGS. 4 and 5. When the loaf 2 is advanced to the receiving compartment 6 for cutting the next slice, the cut portion of the loaf is moved further into the bag 13.

When the bread has been sliced entirely, the push rod 5 is preferably advanced beyond the cutting plane 7 in order to push the cut bread further into the bag and to also introduce the end of the bread 2 facing the push rod 5 in the bag 13. It may be interesting to move the push rod 5 through the opening 14 into the bag 13. Next, the hooks 11 are removed from the bread 2 and return to their retracted position in the push rod 5, which is moved back into the loading compartment 1, as shown in FIG. 6.

The push element 19 is movable in the direction of travel of the bread, such that it can move away from the cutting plane 7 as the cut portion of the bread is being introduced in the bag 13. After a loaf 2 has been put in the loading compartment 1 to be sliced, the packing bag 13 will be kept open as described above and the push element 19 is moved from its rest position, as shown in FIGS. 1 and 2, to a compression position of the packing bag 13 as shown in FIG. 3.

In this compression position, the push element 19 compresses the packing bag 13 close to the opening 14 in order to reduce the cross-section of a portion of the bag 13 and to make this section 21 smaller than the section of the opening 14 and smaller than the cutting surface of a cut slice of the bread 2. Thus, the slice cut from the end of the loaf 2 opposite the one facing the push rod 5 can rest in the bag 13 against the portion 21 of the bag 13 with the reduced section. As a result, this slice will rest against the push element 19 through the bag 13.

While the bread 2 is being cut into slices, the push element 19 is moved in said direction of travel as the cut portion of the bread 2 is being introduced in the bag 13. Thus, the portion 21 of the bag 13 with the reduced section is moved away from the cutting plane 7 simultaneously with the movement of the push rod 5 towards the cutting plane 7, while maintaining the end of the loaf 2 supported by said portion 21 of the bag with the reduced section. In particular, the push element 19 is moved away from the cutting plane 7 along said direction of travel of the bread 2 or parallel to the output table 12 as the bread 2 advances.

According to an interesting embodiment of the invention, the push element 19 cooperates with the push rod 5 so as to allow a synchronized displacement of the push element 19, in particular said rod or roller 29, and of the push rod 5 while the bread 2 is being cut into slices. Thus, a movement is imposed on the push element 19 which is synchronous with the movement of the push rod 5. The push element 19 can be driven, for example, by an electric motor or by the movement of the push rod 5.

In this embodiment, the push element 19 is driven, for example, by an electric motor which ensures that, while the bread is being cut, the distance between the push rod 5 and the push element 19 is maintained substantially constant so that the movement of the push rod 5 and the push element 19 is synchronized.

According to a variant of this embodiment, it is ensured that the average speed of movement of the push element 19 in said direction of travel corresponds to the average speed of the push rod 5 in order to obtain a synchronized movement of the push element 19 and the push rod 5.

Thanks to the synchronized movement of the push element 19 and the push rod 5, it is prevented that the cut slices of bread fall and push against the push element 19, which would cause the push element 19 to advance faster than the bread 2 or the push rod 5. This occurs, for example, when the resistance to the movement of the push element 19 is too low and the slices can fall and move away from each other.

On the other hand, the synchronized movement of the push element 19 and the push rod 5, while the bread is being cut, prevents the cut slices from being compressed against the push element 19 when the latter's resistance to movement is too high.

In practice, a control unit may be provided which controls the motor of the push element 19 and thus regulates the movement of the push element 19, in particular of said rod or the roller 29, in accordance with the movement of the push rod 5 while the bread 2 is being cut. Thus, this control unit ensures that the push element 29 and the push rod 5 undergo a synchronized movement during the cutting of the bread. The control unit determines, for example, the position of the push element 29 and/or regulates the speed of movement of the push element 29 in particular.

Optionally, the push element 19 is moved by the force exerted on the latter by the bread 2 which is pushed by the push rod 5. In this case, the push element 19 cooperates, for example, with a spring which pushes the push element 19 against the bread 2 or which maintains a pressure force between the push element 19 and the cut portion of the bread 2 to prevent the slices from falling. In such a case, said spring, or another device for maintaining this pressure force between the push element 19 and the cut portion of the bread 2, is adjustable according to the type of bread, for example according to the stiffness of the bread, to ensure a synchronized movement of the push element 19 and the push rod 5

In another embodiment of the invention, a synchronized movement of the push element and the push rod is achieved thanks to the presence of a physical connection between the push element and the push rod, such as a connecting bar, for example.

After the bread 2 has been sliced entirely, as shown in FIG. 6, the sucking of the upper side 17 of the bag 13 by the suction cup 18 is completed and the push rod 5 is returned to its initial position. The push element 19 is moved to its rest position and the sliced bread 2 which is packed in the packing bag 13 is removed from the receiving compartment 6, as shown in FIG. 7.

In some cases, the output table 12 may be tilted to the horizontal plane. The level of the opening 14 of the bag 13 is then higher than the level of the portion of the bag 13 with the reduced section. Thus, the cut slices of bread will automatically rest against the portion 21 of the bag 13 with the reduced section due to gravity.

FIG. 8 shows a variant of the preceding embodiment of the slicer according to the invention. In this variant, the slicer comprises a storage space 22 for accommodating a stack 23 of preformed, flat-folded packing bags 13 with their opening 14 directed towards the cutting plane 7.

This storage space 22 has a mobile support 24 for the stack 23 which allows the level of this stack 23 of bags 13 to be adjusted so that the upper surface of the stack 23 extends substantially in the upper plane of the output table 12.

The lower side 25 of the bags 13 is provided with a strip protruding from the opening 14. Thus, this protruding strip is formed by the lower edge 16 of the opening 14 on the lower side 25 of the bag 13. This lower edge 16 extends beyond the upper edge of the opening 14 of the bag. Adjacent to the storage space 22, the lower side of the output table 12 has a rim 28 against which the protruding strip, in particular the edge 16, of the upper bag 13 of the stack 23 is clamped. To this end, the mobile support 24 is pushed towards the output table 12 by means of, for example, a compression spring 26 mounted between this support 24 and the slicer frame. The edge 16 of the top bag 13 of the stack 23 is thus clamped and fixed between the stack 23 of bags 13 and the edge of the output table 12. The holding means thus include said rim 28.

The top bag of the stack 23 is opened by a suction cup 18 which sucks on the upper side 17 of this bag 13, as described in connection with the embodiment of the slicer shown in FIGS. 1 to 7.

After the bread 2 has been sliced entirely and the slices have been introduced in the bag, the bread 2 packed in the bag 13 is removed from the receiving compartment 6. Then, the next bag in the stack 23 is automatically presented and clamped with the lower edge 16 below the rim 28 of the output table 12.

FIG. 9 shows another embodiment of the slicer according to the invention. The main difference between this slicer and those of the previous figures is the presence of a storage space for packing bags 13 and a blowing nozzle 27. This blowing nozzle 27 is part of the opening device and can, for example, be added to the suction cup 18 or can replace this suction cup 18.

The blowing nozzle 27 is thus arranged to generate an air flow towards the surface of the output table 12 and, in particular, substantially along the direction of travel of the bread 2 to open the folded packing bag that is present at the output table 12, and to keep this bag 13 open.

In the embodiment of the invention shown in FIG. 9, the blowing nozzle 27 has a slot that extends substantially parallel to the cutting plane 7 and is parallel to the output table 12. In this particular case, the output table 12 extends at a level that is slightly lower than that of the support surface 4, so that the blowing nozzle 27 extends below the support surface 4 and above the output table 12. Thus, the blowing nozzle 27 makes it possible to generate an air flow towards the surface of the output table 12.

Generally, the blowing nozzle 27 is oriented to form an air flow directed towards the opening 14 of the top bag 13 of the stack 23. Preferably, this air flow is substantially parallel to the bottom side 25 of the bag 13 arranged level with the surface of the output table 12 or, in particular, substantially parallel to the surface of the output table 12.

Thus, this air flow is directed towards the opening 14 of the bag 13 which is folded flat, as shown in FIG. 9, to expand the bag. Thus, the bag 13 is opened by the air flow from the blowing nozzle 27 and is also kept open by this air flow with the opening 14 facing the cutting plane 7. The air flow is maintained at least until a cut slice of bread 2 is introduced in the bag 13 through the opening 14 and preferably until the bagged cut bread is removed from the receiving compartment 6.

In an alternative embodiment, the blowing nozzle 27 may be formed by a slot or a succession of openings provided in the surface of the output table 12 between said clamp 15, or rim 28, and the cutting plane 7.

It is clear that the invention is not limited to the various embodiments described above, but that also other variants may be envisaged while still remaining within the scope of the present invention, particularly with respect to the holding means.

Thus, the holding means may include guide fingers arranged such that they extend on either side of the bread 2 through the opening 14 of the packing bag 13 to keep the bag 13 open and to guide the bread 2 as it is introduced in the bag 13.

The invention is characterized, in particular, by the fact that a loaf of bread to be sliced is pushed in one and the same direction and through a cutting plane for cutting it into slices and into a packing bag.

In the figures, a slicer is shown which has a horizontally extending output table 12 and support surface 4. It is clear that the support surface 4 and/or the output table 12 may also extend in a plane which is inclined with respect to the horizontal.

Although in the above-described embodiments of the invention, the push element 19 extends substantially horizontally, it is also possible for this push element 19 to extend vertically, for example.

In an alternative embodiment, the push element 19 comprises, for example, two mobile rollers which extend on either side of the bag 13 and which can move towards each other in order to reduce the cross-section 21 of the packing bag 13.

It is clear that these rollers can also move in the direction of travel of the bread, so that they can advance while the bread is being sliced.

1. A bread slicer for wrapping a loaf of bread in a packing bag, said slicer comprising:
a loading compartment having a support surface to place a loaf of bread on to be sliced, the loading compartment being connected to a receiving compailinent which has an output table for the sliced bread,
a push rod for pushing the bread from the loading compailinent to the receiving compailinent in a direction of travel of the bread,
a cutting element for cutting successive slices of the bread as the latter is moved from the loading compailinent to the receiving compartment, said cutting element being arranged in a cutting plane between the loading compailinent and the receiving compartment and substantially perpendicular with respect to said direction of travel of the bread,
holder, provided in the receiving compartment, for holding open a packing bag having an opening, with the opening facing the cutting plane while the bread moves along the direction of travel, the push rod being arranged so as to push at least part of the cut bread through the opening of the bag in said direction of travel in order to introduce it at least partially in the packing bag,
a push element which is provided in the receiving compartment and which makes it possible to compress the packing bag when the latter is being held open by the holder in order to reduce the cross-section of the bag (13) at the location of the push element, such that the portion of the bag with the reduced section forms a support for the far end of the bread opposite the end facing the push rod,
wherein the push element can move in the direction of travel of the bread in order to be able to gradually move away from the cutting plane while the cut portion of the bread is being introduced in the bag, wherein the push element cooperates with the push rod so as to allow a synchronized movement of the push element and the push rod while the bread is cut into slices.

2. The bread slicer according to claim 1, wherein the push element has a drive for moving it in the direction of travel of the bread in synchronization with the movement of the push rod while the bread is being cut into slices.

3. The bread slicer according to claim 2, wherein the drive comprises an electric motor.

4. The bread slicer according to claim 1, comprising a control unit for controlling the movement of the push element as a function of the movement of the push rod while the bread is being cut in order to ensure that the push element and the push rod undergo a synchronized movement while the bread is being cut.

5. The bread slicer according to claim 1, comprising a storage space to accommodate a stack of flat-folded packing bags with their opening facing the cutting plane, the storage space having a mobile support for said stack allowing the level of the stack of bags to be adapted so that the upper surface of the stack extends substantially in the plane of the output table.

6. The bread slicer according to claim 1, wherein the holder comprises a clamping element to maintain a lower edge of the opening of the packing bag substantially at the level of the output table and an opening device for holding the upper side of the bag near the opening and for moving this the upper side away from the lower side until the bag opens so as to allow for the introduction of a bread.

7. The bread slicer according to claim 6, wherein the opening device comprises a blowing nozzle arranged to generate an air flow towards the surface of the outlet table and, substantially along the direction of travel of the bread so as to open a flat-folded packing bag which is present at the output table and to keep the bag open.

8. The bread slicer according to claim 6, wherein the opening device comprises at least one suction cup to suck on and hold the upper side of the bag so as to open the bag and keep the bag open.

9. The bread slicer according to claim 1, wherein the holder comprises guide fingers arranged such that they extend on either side of the bread through the opening of the packing bag to keep the bag open and to guide the bread as it is introduced in the bag.

10. The bread slicer according to claim 1, wherein the output table is inclined relative to a horizontal plane to hold the slices of the cut bread against one another while the bread is being introduced in the packing bag.

11. A method for cutting a loaf of bread in slices and for introducing the slices in a packing bag, wherein the bread is placed in a loading compartment and is moved in a direction of travel of the loaf towards a receiving compartment, wherein during the movement, the bread is cut in successive slices by a blade moving in a cutting plane between the loading compartment and the receiving compartment, wherein a packing bag having an opening is being held in the receiving compartment with the opening of the bag directed towards the cutting plane in order to introduce the slices of bread in the packing bag according to said direction of travel as the bread moves, wherein the packing bag is compressed by a push element in order to reduce the cross-section of a portion of the bag while the bag is being held open, such that the end of the bread opposite the end facing the push rod will rest in the bag against the portion of the bag with the reduced cross-section, and in that the push element is moved so as to move the portion with the reduced section away from the cutting plane according to said direction of travel as the sliced portion of the bread is being introduced in the bag while maintaining the far end of the bread supported by said portion of the bag with the reduced section, wherein the bread to be sliced is driven in the loading compartment by a push rod, while being cut, and the push element is made to move synchronously with the push rod.

12. The method according to claim 11, wherein, while the bread is being cut into slices, slices are produced which extend along a plane that is inclined with respect to a vertical plane, such that the slices rest against one another while being introduced in the packing bag.

13. The method according to claim 11, wherein the at least partially sliced bread is introduced in the packing bag in a direction of travel of the bread which extends substantially transversely with respect to the plane of the slices.

14. The method according to claim 11, wherein the position and/or the speed of the push rod during the cutting of the bread, in particular while the bread is moved through the cutting plane, is determined by a control unit, and the push element is moved in said direction of travel in synchronization with the determined position and/or speed of the push rod.
